(19) United States
(12) Patent Application Publication
(10) Pub. No.: US 2025/0220303 A1
(43) Pub. Date: Jul. 3, 2025

(54) ELECTRONIC DEVICE AND METHOD WITH CAMERA FOCUS CONTROL

(71) Applicant: Samsung Electronics Co., Ltd., Suwon-si (KR)

(72) Inventors: Nagyeong LEE, Suwon-si (KR); Hansol KANG, Suwon-si (KR); Donghee KWON, Suwon-si (KR); Donghoon KIM, Suwon-si (KR); Sangwon LEE, Suwon-si (KR); Hana LEE, Suwon-si (KR); Hyong Euk LEE, Suwon-si (KR); Hyun Sung JIN, Suwon-si (KR); Myungsub CHOI, Suwon-si (KR)

(73) Assignee: Samsung Electronics Co., Ltd., Suwon-si (KR)

(21) Appl. No.: 18/825,375

(22) Filed: Sep. 5, 2024

(30) Foreign Application Priority Data
Dec. 28, 2023 (KR) 10-2023-0195109

(51) Int. Cl. H04N 23/67; G02B 7/04

(52) U.S. Cl. CPC H04N 23/672; G02B 7/04

(57) ABSTRACT

A processor-implemented method includes obtaining an image comprising a target object, generating, from the image, a first channel image comprising first phase detection (PD) pixel values and a second channel image comprising second PD pixel values, determining a position of a lens to focus on the target object based on a focus determination model to which the first channel image and the second channel image are input, and controlling a camera according to the position of the lens, wherein the first channel image and the second channel image each comprise PD pixel values for detecting a phase difference in the image, and image pixel values comprising information on the image.

### CROSS-REFERENCE TO RELATED APPLICATIONS

This application claims the benefit under 35 USC § 119 (a) of Korean Patent Application No. 10-2023-0195109, filed on Dec. 28, 2023 in the Korean Intellectual Property Office, the entire disclosure of which is incorporated herein by reference for all purposes.

### BACKGROUND

### 1. Field

The following description relates to an electronic device and method with camera focus control.

### 2. Description of Related Art

Autofocus (AF) technology used in a camera, which automatically focuses, may be key technology that provides convenience to a user when taking photos and videos. To this end, a phase detection method (i.e., phase detection AF (PDAF)) may be mainly used for AF in an image sensor (e.g., a complementary metal oxide semiconductor (CMOS) sensor) currently being used. The phase detection method may use an image sensor including phase detection (PD) pixels that are configured to detect a phase difference.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes obtaining an image comprising a target object, generating, from the image, a first channel image comprising first phase detection (PD) pixel values and a second channel image comprising second PD pixel values, determining a position of a lens to focus on the target object based on a focus determination model to which the first channel image and the second channel image are input, and controlling a camera according to the position of the lens, wherein the first channel image and the second channel image each comprise PD pixel values for detecting a phase difference in the image, and image pixel values comprising information on the image.

The generating of the first channel image comprising the first PD pixel values and the second channel image comprising the second PD pixel values from the image may include generating the first channel image by interpolating pixel values corresponding to second PD pixels in the image based on the image pixel values, and generating the second channel image by interpolating pixel values corresponding to first PD pixels in the image based on the image pixel values.

The generating of the first channel image may include generating the first channel image by interpolating a second PD pixel in the first channel image with an average image pixel value of image pixels adjacent to the second PD pixel, and the generating of the second channel image may include generating the second channel image by interpolating a first PD pixel in the second channel image with an average image pixel value of image pixels adjacent to the first PD pixel.

The generating of the first channel image comprising the first PD pixel values and the second channel image comprising the second PD pixel values from the image may include, in response to a column comprising first PD pixels and a column comprising second PD pixels not overlapping each other in the image, generating the first channel image using the column comprising the first PD pixels and generating the second channel image using the column comprising the second PD pixels.

The determining of the position of the lens may include generating a first channel cropped image comprising the target object from the first channel image, generating a second channel cropped image comprising the target object from the second channel image, and inputting the first channel cropped image and the second channel cropped image to the focus determination model and outputting the position of the lens.

The focus determination model may be a model trained to output the position of the lens for focusing on the target object based on the PD pixel values and the image pixel values included in the first channel image and the second channel image.

The image may be an image generated by an image sensor comprising PD pixels having a density less than or equal to a threshold density.

The image pixel values comprising the information on the image may include either one or both of a value of image pixels adjacent to PD pixels in the image and a value of all image pixels included in an image sensor.

The generating of the first channel image may include determining a value of a second PD pixel in the first channel image based on values of image pixels adjacent to the second PD pixel.

The values of image pixels adjacent to the second PD pixel may exclude a value of a first PD pixel adjacent to the second PD pixel.

In one or more general aspects, a non-transitory computer-readable storage medium may store instructions that, when executed by one or more processors, configure the one or more processors to perform any one, any combination, or all of operations and/or methods disclosed herein.

In one or more general aspects, a processor-implemented method includes obtaining an image comprising a target object, generating, from the image, a first channel image comprising first phase detection (PD) pixel values and a second channel image comprising second PD pixel values, determining a position of a lens to focus on the target object based on a focus determination model to which the first channel image and the second channel image are input, and controlling a camera according to the position of the lens, wherein the image is generated by an image sensor comprising PD pixels having a density less than or equal to a threshold density, and wherein the first channel image and the second channel image are generated to be different depending on a pattern of PD pixels included in the image sensor.

In one or more general aspects, an electronic device includes one or more processors configured to obtain an image comprising a target object, generate, from the image, a first channel image comprising first phase detection (PD) pixel values and a second channel image comprising second PD pixel values, determine a position of a lens to focus on the target object based on a focus determination model to which the first channel image and the second channel image are input, and control a camera according to the position of the lens, and wherein the first channel image and the second channel image each comprise PD pixel values for detecting a phase difference in the image, and image pixel values comprising information on the image.

For the generating of the first channel image comprising and the second channel image, the one or more processors may be configured to generate the first channel image by interpolating pixel values corresponding to second PD pixels in the image based on the image pixel values, and generate the second channel image by interpolating pixel values corresponding to first PD pixels in the image based on the image pixel values.

The one or more processors may be configured to for the generating of the first channel image, generate the first channel image by interpolating a second PD pixel in the first channel image with an average image pixel value of image pixels adjacent to the second PD pixel, and for the generating of the second channel image, generate the second channel image by interpolating a first PD pixel in the second channel image with an average image pixel value of image pixels adjacent to the first PD pixel.

For the generating of the first channel image and the second channel image, the one or more processors may be configured to, in response to a column comprising first PD pixels and a column comprising second PD pixels not overlapping each other in the image, generate the first channel image using the column comprising the first PD pixels and generate the second channel image using the column comprising the second PD pixels.

For the determining of the position of the lens, the one or more processors may be configured to generate a first channel cropped image comprising the target object from the first channel image, generate a second channel cropped image comprising the target object from the second channel image, and input the first channel cropped image and the second channel cropped image to the focus determination model and output the position of the lens.

The focus determination model may be a model trained to output the position of the lens for focusing on the target object based on PD pixel values and image pixel values included in the first channel cropped image and the second channel cropped image, in response to receiving the first channel cropped image and the second channel cropped image as input.

The image may be an image generated by an image sensor comprising PD pixels having a density less than or equal to a threshold density.

The image pixel values comprising the information on the image may include either one or both of a value of image pixels adjacent to PD pixels in the image and a value of all image pixels included in an image sensor.

Other features and aspects will be apparent from the following detailed description, the drawings, and the claims.

### BRIEF DESCRIPTION OF THE DRAWINGS

FIG. 1 illustrates an example of an electronic device.

FIG. 2 illustrates an example of image sensors.

FIG. 3 illustrates a flowchart of an example of an operating method of an electronic device.

FIGS. 4 to 6 illustrate examples of a method of generating two channel images.

FIG. 7 illustrates an example of a focus determination model.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms used herein including technical and scientific terms have the same meanings as those commonly understood by one of ordinary skill in the art to which this disclosure pertains and based on an understanding of the disclosure of the present application. Terms such as those defined in commonly used dictionaries are to be interpreted as having a meaning that is consistent with their meaning in the context of the relevant art and the disclosure of the present application, and are not to be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

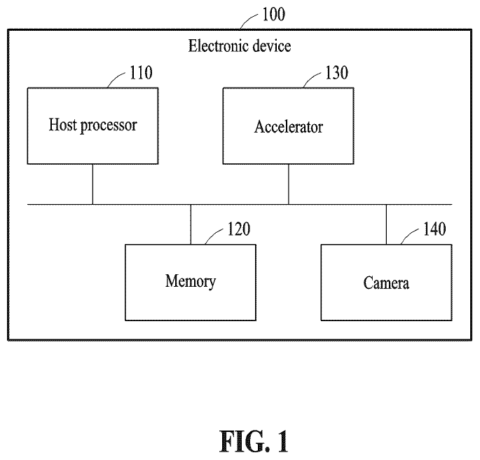

Hereinafter, the examples are described in detail with reference to the accompanying drawings. When describing the examples with reference to the accompanying drawings, like reference numerals refer to like components and a repeated description related thereto is omitted. FIG. 1 illustrates an example of an electronic device.

Referring to FIG. 1, an electronic device 100 may include a host processor 110 (e.g., one or more processors), a memory 120 (e.g., one or more memories), an accelerator 130, and a camera 140. The host processor 110, the memory 120, and the accelerator 130 may communicate with each other through a bus, a network on a chip (NoC), a peripheral component interconnect express (PCIe), and the like. Only the components related to the example described herein are illustrated as being included in the electronic device 100 of FIG. 1. Thus, it will be understood by one of ordinary skill in the art with an understand of the present disclosure that the electronic device 100 may also include other general-purpose components in addition to the components illustrated in FIG. 1. The electronic device 100 may be a device that is to capture a high-definition image using an image sensor of a limited size. For example, the electronic device 100 may be a small electronic device such as a smartphone, a small closed-circuit television (CCTV), and/or a robot vacuum cleaner. For example, the electronic device 100 may be a device that uses an autofocus (AF) function used in various industries (e.g., semiconductor and/or medical imaging).

The host processor 110 may perform overall functions for controlling the electronic device 100. The host processor 110 may control the electronic device 100 overall by executing programs and/or instructions stored in the memory 120. The host processor 110 may be implemented as a central processing unit (CPU), a graphics processing unit (GPU), an application processor (AP), and/or the like that are included in the electronic device 100. However, examples are not limited thereto.

The memory 120 may be hardware for storing data that is to be processed or that has been processed in the electronic device 100. In addition, the memory 120 may store an application, a driver, and the like to be driven by the electronic device 100. The memory 120 may include instructions executable by the host processor 110. For example, the memory 120 may include a non-transitory computer-readable storage medium storing instructions that, when executed by the host processor 110, configure the host processor 110 to perform any one, any combination, or all of operations and/or methods disclosed herein with reference to FIGS. 1-7. The memory 120 may include a volatile memory (e.g., dynamic random-access memory (DRAM)) and/or a non-volatile memory.

The electronic device 100 may include the accelerator 130 for an operation. The accelerator 130 may process tasks that, due to the characteristics of the tasks, may be more efficiently processed by a separate dedicated processor, such as the accelerator 130, than by a general-purpose processor, e.g., the host processor 110. In this example, one or more processing elements (PEs) included in the accelerator 130 may be used. The accelerator 130 may correspond to, for example, a neural processing unit (NPU), a tensor processing unit (TPU), a digital signal processor (DSP), a GPU, a neural engine, and/or the like that perform an operation according to a neural network.

The camera 140 may take a still image and a video. The camera 140 may include one or more lenses, image sensors, image signal processors, and/or flashes.

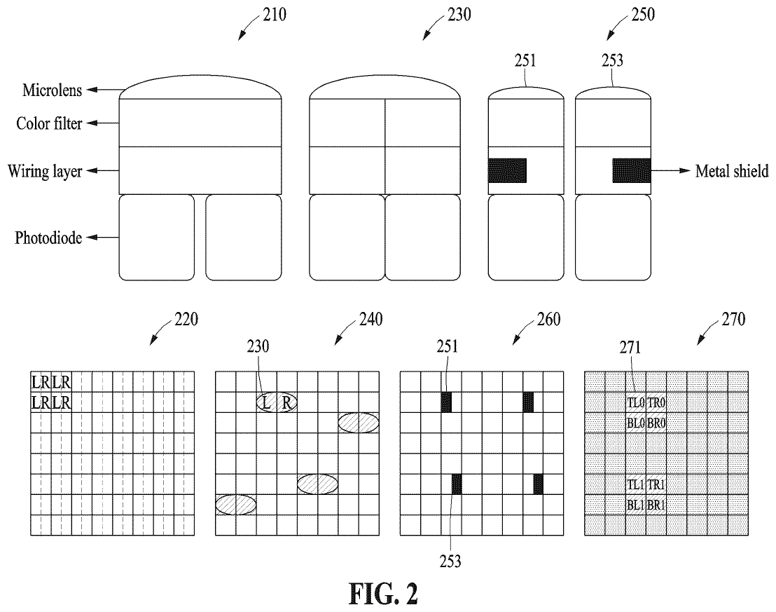

Hereinafter, a method of focusing using image pixels as well as phase detection (PD) pixels, when a camera includes an image sensor including PD pixels that function as focus pixels for focusing and do not function as image pixels, is described. Referring to FIG. 2, an example of an image sensor to which the method described herein is applicable is described. FIG. 2 illustrates an example of image sensors.

Referring to FIG. 2, different PD pixels and image sensors including each PD pixel are shown.

Phase detection autofocus (PDAF) may be a method of determining phase difference by comparing values of two adjacent PD pixels and tracking a point on which phases become the same. In an in-focus situation, the phase difference may be “0.” In an out-of-focus situation, the phase difference may not be “0.” Depending on an implementation method, various PD pixels may exist as shown in FIG. 2. The PD pixels and image sensors shown in FIG. 2 are only examples, and the present disclosure is not limited thereto.

A PD pixel 210 may include two photodiodes in one pixel. These pixels may be referred to as a dual photodiode. AF may be performed based on a difference in output between photodiodes. Referring to FIG. 2, an image sensor 220 including a PD pixel 210 is shown. For ease of description, left L and right R are indicated for only some pixels, and the image sensor 220 including 64 pixels (e.g., 64 PD pixels 210) is shown. Each pixel in the image sensor 220 may be a PD pixel 210. Here, the PD pixel 210 may function as a focus pixel during a focusing time. In addition, the PD pixel 210 may function as an image pixel during an imaging time, which refers to the time for taking an image. The PD pixel 210 may refer to a pixel configured to detect a phase difference. An image pixel may refer to a pixel used to output an image in which a phase difference is not detected. For example, all pixels in the image sensor 210 may be both a PD pixel configured to detect a phase difference and an image pixel used to output an image. When all pixels included in the image sensor 220 are a PD pixel that functions as a focus pixel during a focusing time, AF performance of a camera may be superior to that of the image sensors described below.

Hereinafter, for ease of description, it is assumed that PD pixels are arranged horizontally. However, it will be understood by one of ordinary skill in the art with an understanding of the present disclosure that the following descriptions may be applied to various arrangements, such as PD pixels arranged vertically as well as PD pixels arranged horizontally.

A PD pixel 230 may have a structure in which one microlens covers two pixels. AF may be performed using a phase difference between two pixels covered together by a single microlens. Referring to FIG. 2, an image sensor 240 including the PD pixel 230 is shown. Referring to the image sensor 240, unlike the image sensor 220, the PD pixel 230 may be disposed only on a portion of the image sensor 240. For example, only some of the pixels in the image sensor 240 may be the PD pixels 230 and the other pixels may be image pixels. In this example, in the image sensor 240, only the PD pixels 230 may be used for AF using a phase difference, unlike in the image sensor 220.

A PD pixel 250 may have a structure in which left and right sides are shielded respectively by inserting a metal shield into a wiring layer. AF may be performed using a pair of phase differences obtained from a pair of PD pixels of which the left and right sides are shielded respectively. For example, AF may be performed based on a pair of phase differences obtained from a left PD pixel 251 having the left side shielded and a right PD pixel 253 having the right side shielded. Referring to FIG. 2, an image sensor 260 including a PD pixel 250 is shown. Referring to the image sensor 260, unlike the image sensor 220, the PD pixel 250 may be disposed only on a portion of the image sensor 260. For example, only some of the pixels in the image sensor 260 may be the PD pixels 250 and the other pixels may be image pixels. In this example, in the image sensor 260, only the PD pixels 250 may be used for AF using a phase difference, unlike the image sensor 220.

In an image sensor 270, PD pixels 271 may be arranged vertically and horizontally. For example, the image sensor 270 may include a top left PD pixel TL0, a top right PD pixel TR0, a bottom left PD pixel BL0, and a bottom right PD pixel BR0. In this example, AF may be performed based on one or more pairs of phase differences obtained by the image sensor 270. For example, AF may be performed based on a phase difference between the pair of TL0 and TR0 and a phase difference between the pair of BL0 and BR0. In addition, for example, AF may be performed based on a phase difference between the pair of TL0 and BL0 and a phase difference between the pair of TR0 and BR0. However, the phase differences of the pairs described above are only examples, and the present disclosure is not limited thereto.

In conclusion, unlike in the image sensor 220, the PD pixels in the image sensor 240 and the image sensor 260 may only be used to focus and may not function as an image pixel. As a result, the PD pixels in the image sensor 240 and the image sensor 260 may be treated as bad pixels during an imaging time. In conclusion, a process of removing bad pixels (i.e., bad pixel correction (BPC)) generated by the PD pixels may be further performed on an image. As a result, more PD pixels may be used to increase AF performance, but image quality may degrade when more PD pixels are included in an image sensor. On the contrary, when PD pixels are reduced in order to improve image quality, the amount of information for phase detection may be reduced, thereby reducing AF performance.

Therefore, a method of one or more embodiments of improving AF performance using values of image pixels when a density of PD pixels is less than a threshold density (e.g., when PD pixels exist sparsely), as in the cases of the image sensor 240 and the image sensor 260, is described herein.

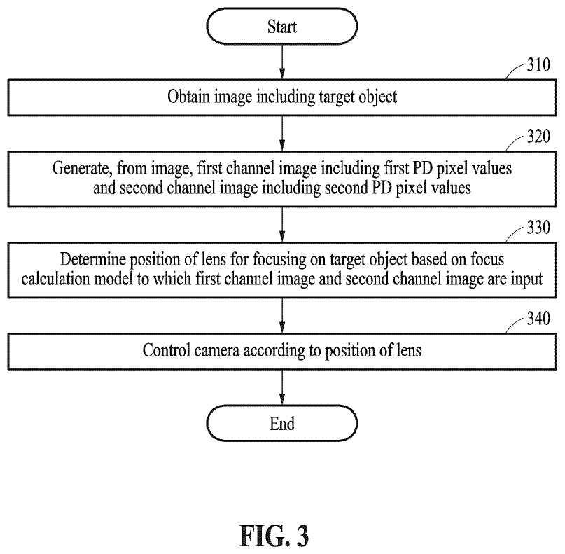

FIG. 3 illustrates a flowchart of an example of an operating method of an electronic device.

In the following example, operations may be performed sequentially, but not necessarily. For example, the order of one or more of the operations may be changed, and two or more of the operations may be performed in parallel. Operations shown in FIG. 3 may be performed by at least one component of the electronic device.

In operation 310, the electronic device may obtain an image including a target object.

The target object may be an object to focus on. The electronic device may take an image of the target object in response to receiving a command to focus on the target object. The command may be a command to direct a focus from another object to the target object. The command may be a command to focus on a target object located at the center of a display module that displays an image input from a camera. When the display module is configured to receive a touch input, the command may be generated by touching the target object on the display module. Alternatively, the command may be generated by lightly pushing a shutter (i.e., half-shutter) while the target object is located in the center of the display module.

In operation 320, the electronic device may generate, from the image, a first channel image including first PD pixel values and a second channel image including second PD pixel values.

The first PD pixel values and the second PD pixel values may vary depending on an arrangement of the PD pixels. For example, when a pair of PD pixels is arranged horizontally as in the image sensor 240 of FIG. 2, a first PD pixel value may be a left PD pixel value, and a second PD pixel value may be a right PD pixel value. In addition, for example, when a pair of PD pixels is arranged vertically on an image sensor, the first PD pixel value may be an upper PD pixel value, and the second PD pixel value may be a lower PD pixel value. For example, the first PD pixel value and the second PD pixel value may be determined in various ways depending on the arrangement of the PD pixels.

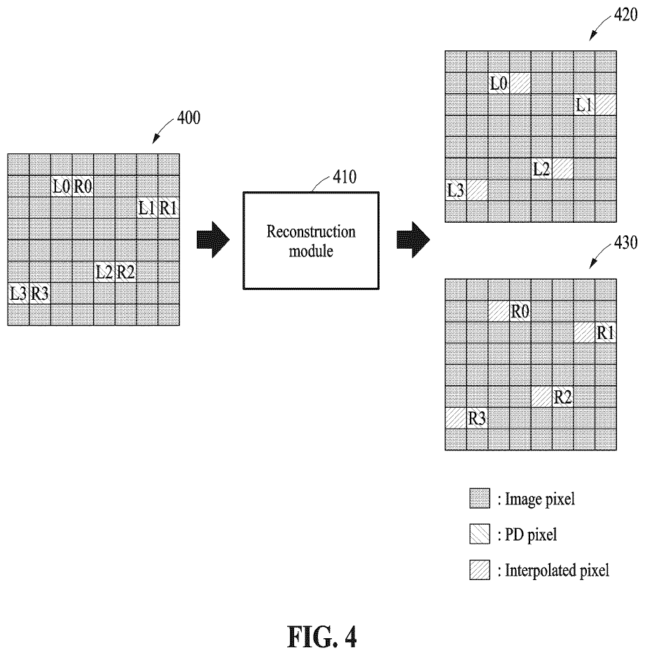

That is, the electronic device may preprocess an image before inputting the preprocessed image to a focus determination model. The electronic device may generate, from the image, a first channel image including first PD pixel values and a second channel image including second PD pixel values through preprocessing. The first channel image may include PD pixel values (e.g., the first PD pixel values) used to detect phase difference in the image and image pixel values including information on the image. Similarly, the second channel image may include PD pixel values (e.g., the second PD pixel values) used to detect phase difference in the image and image pixel values including information on the image. An example of a method of generating the first channel image and the second channel image is further described below with reference to FIGS. 4 to 6.

In operation 330, the electronic device may determine a position of a lens for focusing on the target object based on the focus determination model to which the first channel image and the second channel image are input.

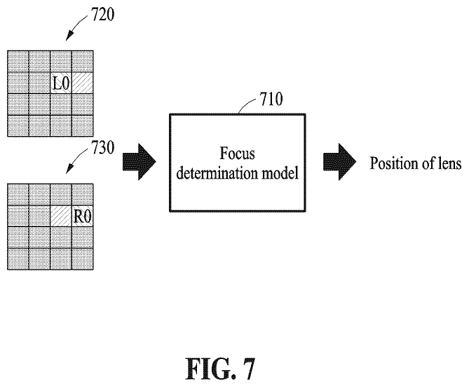

An example of a method of determining the position of the lens based on the focus determination model is further described below with reference to FIG. 7.

In operation 340, the electronic device may control a camera according to the position of the lens.

By controlling the camera according to the position of the lens, the target object may be focused.

Hereinafter, a method of preprocessing the image is described.

FIGS. 4 to 6 illustrate examples of a method of generating two channel images.

Referring to FIGS. 4 to 6, for ease of description, a first PD pixel value and a second PD pixel value are assumed to be a left PD pixel value and a right PD pixel value, respectively. However, it will be understood by one of ordinary skill in the art with an understanding of the present disclosure that the descriptions given with reference to FIGS. 4 to 6 may apply to various PD pixel arrangements.

Referring to FIG. 4, a diagram is shown illustrating a method of generating two channel images.

Referring to FIG. 4, an image 400 is shown. The image 400 may have various patterns depending on a pattern of an image sensor used to obtain the image 400. Here, the pattern may refer to an arrangement of PD pixels in the image sensor. Pixels corresponding to a position of a PD pixel in the image 400 may include a PD pixel value. Pixels corresponding to a position of an image pixel in the image 400 may include an image pixel value. For ease of description, in the image 400, a pixel including a PD pixel value is referred to as a PD pixel, and a pixel including an image pixel value is referred to as an image pixel. For example, it should be understood that a PD pixel and an image pixel of an image do not refer to a PD pixel and an image pixel of an image sensor.

For ease of description, the image 400 obtained from the image sensor 240 of FIG. 2 is used, but it will be understood by one of ordinary skill in the art with an understanding of the present disclosure that the following description may apply to an image generated from an image sensor having various patterns.

The image 400 may include RAW data. Referring to the image 400, PD pixels, which are a portion of pixels, but not image pixels may be used for AF. In the image 400, L0, L1, L2, and L3 may be left PD pixels. In the image 400, R0, R1, R2, and R3 may be right PD pixels. In the image 400, the pixels other than the PD pixels may be image pixels.

An electronic device may input the image 400 to a reconstruction module 410. When receiving the image 400 as input, the reconstruction module 410 may generate two channel images from the image 400. The two channel images may include a first channel image 420 and a second channel image 430.

When a first channel image 420 is compared to an image 400, only pixel values corresponding to right PD pixels may be different. When a second channel image 430 is compared to the image 400, only pixel values corresponding to left PD pixels may be different.

The reconstruction module 410 may delete the pixel values corresponding to the right PD pixels from the image 400 to generate the first channel image 420. In addition, the reconstruction module 410 may interpolate the pixel values corresponding to the right PD pixels based on image pixel values. The reconstruction module 410 may delete pixel values corresponding to the left PD pixels from the image 400 to generate the second channel image 430. In addition, the reconstruction module 410 may interpolate the pixel values corresponding to the left PD pixels based on image pixel values.

Interpolation of a pixel value corresponding to the right PD pixels and a pixel value corresponding to the left PD pixels may be performed using various methods.

The reconstruction module 410 may generate the first channel image 420 from the image 400 by interpolating a right PD pixel of which the pixel value has been deleted, based on image pixels nearest to the right PD pixel. The reconstruction module 410 may interpolate the right PD pixel of which the pixel value has been deleted with an average image pixel value of the image pixels, which are the pixels other than the PD pixels, among the nearest pixels. For example, the reconstruction module 410 may determine an average value of a total of 7 image pixel values excluding the left PD pixel among 8 pixels surrounding (e.g., immediately adjacent to) the right PD pixel of which the pixel value has been deleted and may interpolate the right PD pixel of which the pixel value has been deleted with the average value. Similarly, the reconstruction module 410 may generate the second channel image 430 from the image 400 by interpolating a left PD pixel of which the pixel value has been deleted, based on image pixels nearest to the left PD pixel. The reconstruction module 410 may interpolate the left PD pixel of which the pixel value has been deleted with an average image pixel value of the image pixels, which are the pixels other than the PD pixels, among the nearest pixels. For example, the reconstruction module 410 may determine an average value of a total of 7 image pixel values excluding the right PD pixel among 8 pixels surrounding the left PD pixel of which the pixel value has been deleted and may interpolate the left PD pixel of which the pixel value has been deleted with the average value.

When the pixels nearest (e.g., immediately adjacent) to the PD pixel of which the pixel value has been deleted (that is, 8 pixels surrounding the PD pixel of which the pixel value has been deleted) are layer 1 and the pixels surrounding the layer 1 (that is, 16 pixels) are layer 2, an average value of image pixels included in the layer 1 and the layer 2 (that is, a total of 24 pixels) may be used to interpolate the PD pixel of which the pixel value has been deleted. However, this is only an example, and will be understood by one of ordinary skill in the art with an understanding of the present disclosure that the PD pixel of which the pixel value has been deleted may be interpolated using image pixels included in the layer 1 to a layer N (here, N is a natural number greater than “1,” and the layer N includes pixels surrounding a layer N−1).

The PD pixel of which the pixel value has been deleted may be interpolated by dividing the image 400 into a plurality of images and using an average value of image pixels included in the divided images. For example, the image 400 may be divided into four images, each of which has a size of 4×4, and the PD pixel, of which the pixel value has been deleted, may be interpolated with the average value of the image pixels included in the divided images.

In addition, a method of generating a relationship between a pixel value interpolated by the above method and an actual pixel value and interpolating using the relationship may be used. In addition, a learning-based sparse-to-dense model may be used to interpolate a right PD pixel value in the first channel image 420 and to interpolate a left PD pixel value in the second channel image 430. A sparse-to-dense model may be trained using a machine learning model such as an artificial neural network model.

However, the above-described interpolation method is only an example, and the present disclosure is not limited thereto.

In conclusion, the reconstruction module 410 may generate two channel images by using the image pixel values from the image 400 without a change.

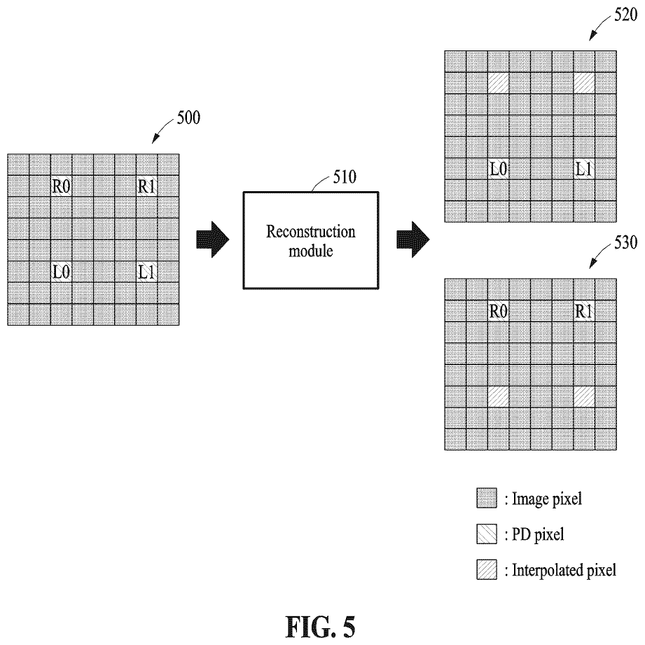

Referring to FIG. 5, a diagram is shown illustrating generating two channel images from an image generated by an image sensor having a different pattern from that shown in FIG. 4.

Referring to FIG. 5, an image 500 is shown. The image 500 may have various patterns depending on a pattern of an image sensor used to obtain the image 500. Here, the pattern may refer to an arrangement of PD pixels in the image sensor. Pixels corresponding to a position of a PD pixel in the image 500 may include a PD pixel value. Pixels corresponding to a position of an image pixel in the image 500 may include an image pixel value. For ease of description, in the image 500, a pixel including a PD pixel value is referred to as a PD pixel, and a pixel including an image pixel value is referred to as an image pixel. For example, it should be understood that a PD pixel and an image pixel of an image do not refer to a PD pixel and an image pixel of an image sensor.

For ease of description, the image 500 obtained from the image sensor 260 of FIG. 2 is used, but it will be understood by one of ordinary skill in the art with an understanding of the present disclosure art that the following description may apply to an image generated from an image sensor having various patterns.

The image 500 may include RAW data. Referring to the image 500, PD pixels, which are a portion of pixels, but not image pixels may be used for AF. In the image 500, L0 and L1 may be left PD pixels. In the image 500, R0 and R1 may be right PD pixels. In the image 500, the pixels other than the PD pixels may be image pixels. Since the image 500 has been generated from a different image sensor from the image 400 of FIG. 4, the pattern may be different from the image 400 of FIG. 4.

However, since it will be understood by one of ordinary skill in the art with an understanding of the present disclosure that the descriptions given with reference to FIG. 4 may apply to a method of generating two channel images shown in FIG. 5, a description of a method in which a reconstruction module 510 generates a first channel image 520 and a second channel image 530 is omitted herein.

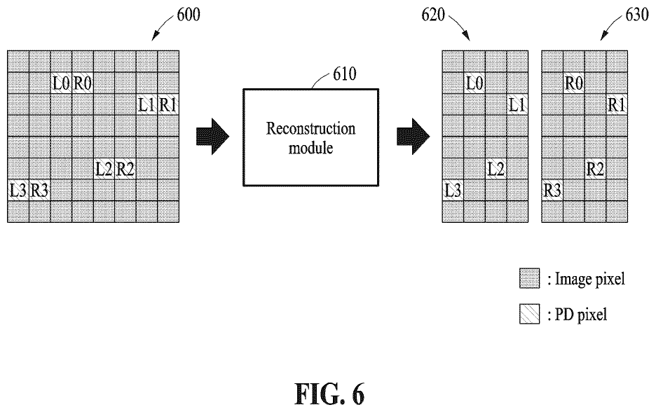

Referring to FIG. 6, a diagram is shown illustrating preprocessing of an image when left PD pixels and right PD pixels exist in different positions.

Referring to FIG. 6, an image 600 is shown. The image 600 may have various patterns depending on a pattern of an image sensor used to obtain the image 600. Here, the pattern may refer to an arrangement of PD pixels in the image sensor. Pixels corresponding to a position of a PD pixel in the image 600 may include a PD pixel value. Pixels corresponding to a position of an image pixel in the image 600 may include an image pixel value. For ease of description, in the image 600, a pixel including a PD pixel value is referred to as a PD pixel, and a pixel including an image pixel value is referred to as an image pixel. For example, it should be understood that a PD pixel and an image pixel of an image do not refer to a PD pixel and an image pixel of an image sensor.

For ease of description, the image 600 obtained from the image sensor 240 of FIG. 2 is used, but it will be understood by one of ordinary skill in the art with an understanding of the present disclosure that the following description may apply to an image generated from an image sensor having various patterns.

The image 600 may include RAW data. Referring to the image 600, PD pixels, which are a portion of pixels, but not image pixels may be used for AF. In the image 600, L0, L1, L2, and L3 may be left PD pixels. In the image 600, R0, R1, R2, and R3 may be right PD pixels. In the image 600, the pixels other than the PD pixels may be image pixels.

Referring to the image 600, the left PD pixels and the right PD pixels may exist in different columns. L3 may exist in column 1, L0 in column 3, L2 in column 5, and L1 in column 7. R3 may exist in column 2, R0 in column 4, R2 in column 6, and R1 in column 8. In this example, a reconstruction module 610 may configure a first channel image 620 and a second channel image 630 with pixel values that do not overlap.

When the left PD pixels and the right PD pixels exist in different columns, the reconstruction module 610 may generate the first channel image 620 using columns including the left PD pixels and may generate the second channel image 630 using columns including the right PD pixels. Here, a size of each channel image may be reduced to half the size of the image 600. In addition, when the first channel image 620 and the second channel image 630 may include different columns of the image 600, the first channel image 620 and the second channel image 630 may include pixel values that do not overlap with each other.

However, the above description may apply to an example where left PD pixels and right PD pixels exist in different rows. For example, when the left PD pixels and the right PD pixels exist in different rows, the reconstruction module 610 may generate the first channel image 620 using rows including the left PD pixels and may generate the second channel image 630 using rows including the right PD pixels.

In the above method of FIG. 6, the interpolation described with reference to FIGS. 4 and 5 may not be necessary because the first channel image 620 and the second channel image 630 include different columns (or different rows). In conclusion, in this example, since interpolation is not necessary and the pixel values do not overlap, the AF of one or more embodiments may more efficiently be performed than in the cases described with reference to FIGS. 4 and 5. Thus, before generating two channel images according to the method described with reference to FIG. 4 or FIG. 5, the electronic device may determine whether the column (or the row) including the left PD pixels is different from the column (or the row) including the right PD pixels. Here, when the column (or the row) including the left PD pixels is different from the column (or the row) including the right PD pixels, the electronic device may generate two channel images according to FIG. 6. Here, when the column (or the row) including the left PD pixels and the column (or the row) including the right PD pixels overlap each other, the electronic device may generate two channel images according to FIG. 4 or FIG. 5.

In conclusion, a pattern of the obtained image may vary depending on a pattern of PD pixels included in an image sensor. In addition, a first channel image and a second channel image may be generated in different ways depending on the pattern the pattern. For example, preprocessing to be performed may vary depending on the pattern.

A reconstruction module may output channel images according to a number of phases divided by PD pixels. Accordingly, since the images in FIGS. 4 to 6 each include a left phase and a right phase, two channel images may be output. Accordingly, since an image generated from the image sensor 270 of FIG. 2 may include four phases, four channel images may be generated from the image. For example, when a number of phases divided by PD pixels in an image sensor is “n,” a reconstruction module may output “n” channel images.

Hereinafter, a method of outputting a position of a lens using the two channel images generated using the above methods is described.

FIG. 7 illustrates an example of a focus determination model.

Before inputting the two channel images generated using the above methods to the focus determination model, an electronic device may crop each channel image to obtain an image including a target object. For example, the electronic device may crop a first channel image to generate a first channel cropped image 720 including the target object. The electronic device may crop a second channel image to generate a second channel cropped image 730 including the target object. The first channel cropped image 720 and the second channel cropped image 730 may include an interpolated pixel value. The interpolated pixel value may be based on adjacent image pixel values and may thus be referred to as an image pixel value.

The electronic device may input the first channel cropped image 720 and the second channel cropped image 730 to a focus determination model 710 to output a position of a lens. Here, the position of the lens may refer to a position on which lenses included in a camera are to be disposed in order to focus on the target object.

The focus determination model 710 may be a model trained to output the position of the lens for focusing on the target object when receiving the first channel cropped image 720 and the second channel cropped image 730. The focus determination model 710 may be a model trained to output the position of the lens for focusing on the target object based on PD pixel values and image pixel values included in the first channel cropped image 720 and the second channel cropped image 730. For example, the focus determination model 710 may use the image pixels as well as the PD pixels included in the first channel cropped image 720 and the second channel cropped image 730 to determine the position of the lens. For example, the focus determination model 710 may be a learning model having a structure of a convolutional neural network (CNN) model. However, this is only an example, and the focus determination model 710 may be another machine learning-based model depending on an amount of determination and a type of output value, and the output value of the model may be in a form of disparity. For example, the focus determination model 710 may be composed of a classification model that predicts a class corresponding to one of “M” predetermined positions depending on how the output value is defined. For example, the focus determination model 710 may be composed of a regression model that directly predicts a specific value corresponding to a movable range of the lens.

Image sensors used in the present disclosure may be sensors having a PD pixel density that is less than or equal to a threshold density. The threshold density may be determined in various ways. For example, the threshold density may be ⅛ or 1/32. Accordingly, an image obtained by these image sensors may include a low-density PD pixel value. AF performance may degrade when a low-density PD pixel value is included. Therefore, in order to prevent AF accuracy from being reduced by a low-density PD pixel value, the focus determination model 710 of one or more embodiments may extract context information around a PD pixel and use the extracted context information. For example, the focus determination model 710 may learn the context information around the PD pixel by receiving image pixels as well as the PD pixel as input.

When receiving the first channel cropped image 720 and the second channel cropped image 730 as input, the focus determination model 710 may output the position of the lens for focusing on the target object using the context information around the PD pixel obtained from the image pixels and the PD pixel value included in each of the channel cropped images. The context information may include information such as an appearance, location, size, and color of the target object. The context information may include not only information on the target object but also information related to the target object, such as a background, another object, lighting, and shadow. The focus determination model 710 may output the position of the lens for focusing on the target object based on a phase difference obtained from the PD pixel value and the context information. The focus determination model 710 may improve AF performance using the context information when the target object to focus on is not clear (for example, in a low light level environment or when the target object lacks texture). AF performance of an image sensor including PD pixels having a density less than or equal to the threshold density may degrade in low light. However, the AF performance may be improved using the method of one or more embodiments described herein.

The electronic device may control the camera according to the position of the lens output from the focus determination model 710. For example, the electronic device may control a distance between the lenses included in the camera to be on the position of the lens output from the focus determination model 710 by controlling a motor included in the camera.

The electronic devices, host processors, memories, accelerators, cameras, PD pixels, image sensors, reconstruction modules, electronic device 100, host processor 110, memory 120, accelerator 130, camera 140, PD pixel 210, image sensor 220, PD pixel 230, image sensor 240, PD pixel 250, left PD pixel 251, right PD pixel 253, image sensor 260, image sensor 270, PD pixels 271, reconstruction module 410, reconstruction module 510, and reconstruction module 610 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method of an electronic device, the method comprising:
obtaining an image comprising a target object;
generating, from the image, a first channel image comprising first phase detection (PD) pixel values and a second channel image comprising second PD pixel values;
determining a position of a lens to focus on the target object based on a focus determination model to which the first channel image and the second channel image are input; and
controlling a camera according to the position of the lens,
wherein the first channel image and the second channel image each comprise:
PD pixel values for detecting a phase difference in the image; and
image pixel values comprising information on the image.

2. The method of claim 1, wherein the generating of the first channel image comprising the first PD pixel values and the second channel image comprising the second PD pixel values from the image comprises:
generating the first channel image by interpolating pixel values corresponding to second PD pixels in the image based on the image pixel values; and
generating the second channel image by interpolating pixel values corresponding to first PD pixels in the image based on the image pixel values.

3. The method of claim 2,
wherein the generating of the first channel image comprises generating the first channel image by interpolating a second PD pixel in the first channel image with an average image pixel value of image pixels adjacent to the second PD pixel, and
wherein the generating of the second channel image comprises generating the second channel image by interpolating a first PD pixel in the second channel image with an average image pixel value of image pixels adjacent to the first PD pixel.

4. The method of claim 1, wherein the generating of the first channel image comprising the first PD pixel values and the second channel image comprising the second PD pixel values from the image comprises, in response to a column comprising first PD pixels and a column comprising second PD pixels not overlapping each other in the image, generating the first channel image using the column comprising the first PD pixels and generating the second channel image using the column comprising the second PD pixels.

5. The method of claim 1, wherein the determining of the position of the lens comprises:
generating a first channel cropped image comprising the target object from the first channel image;
generating a second channel cropped image comprising the target object from the second channel image; and
inputting the first channel cropped image and the second channel cropped image to the focus determination model and outputting the position of the lens.

6. The method of claim 5, wherein the focus determination model is a model trained to output the position of the lens for focusing on the target object based on the PD pixel values and the image pixel values included in the first channel image and the second channel image.

7. The method of claim 1, wherein the image is an image generated by an image sensor comprising PD pixels having a density less than or equal to a threshold density.

8. The method of claim 1, wherein the image pixel values comprising the information on the image comprise either one or both of a value of image pixels adjacent to PD pixels in the image and a value of all image pixels included in an image sensor.

9. The method of claim 1, wherein the generating of the first channel image comprises determining a value of a second PD pixel in the first channel image based on values of image pixels adjacent to the second PD pixel.

10. The method of claim 9, wherein the values of image pixels adjacent to the second PD pixel excludes a value of a first PD pixel adjacent to the second PD pixel.

11. A non-transitory computer-readable storage medium storing instructions that, when executed by one or more processors, configure the one or more processors to perform the method of claim 1.

12. A processor-implemented method of an electronic device, the method comprising:
obtaining an image comprising a target object;
generating, from the image, a first channel image comprising first phase detection (PD) pixel values and a second channel image comprising second PD pixel values;
determining a position of a lens to focus on the target object based on a focus determination model to which the first channel image and the second channel image are input; and
controlling a camera according to the position of the lens,
wherein the image is generated by an image sensor comprising PD pixels having a density less than or equal to a threshold density, and
wherein the first channel image and the second channel image are generated to be different depending on a pattern of PD pixels included in the image sensor.

13. An electronic device comprising:
one or more processors configured to:
obtain an image comprising a target object;
generate, from the image, a first channel image comprising first phase detection (PD) pixel values and a second channel image comprising second PD pixel values;
determine a position of a lens to focus on the target object based on a focus determination model to which the first channel image and the second channel image are input; and
control a camera according to the position of the lens, and
wherein the first channel image and the second channel image each comprise:
PD pixel values for detecting a phase difference in the image; and
image pixel values comprising information on the image.

14. The electronic device of claim 13, wherein, for the generating of the first channel image comprising and the second channel image, the one or more processors are configured to:
generate the first channel image by interpolating pixel values corresponding to second PD pixels in the image based on the image pixel values; and
generate the second channel image by interpolating pixel values corresponding to first PD pixels in the image based on the image pixel values.

15. The electronic device of claim 14, wherein the one or more processors are configured to:
for the generating of the first channel image, generate the first channel image by interpolating a second PD pixel in the first channel image with an average image pixel value of image pixels adjacent to the second PD pixel; and
for the generating of the second channel image, generate the second channel image by interpolating a first PD pixel in the second channel image with an average image pixel value of image pixels adjacent to the first PD pixel.

16. The electronic device of claim 13, wherein, for the generating of the first channel image and the second channel image, the one or more processors are configured to, in response to a column comprising first PD pixels and a column comprising second PD pixels not overlapping each other in the image, generate the first channel image using the column comprising the first PD pixels and generate the second channel image using the column comprising the second PD pixels.

17. The electronic device of claim 13, wherein, for the determining of the position of the lens, the one or more processors are configured to:
generate a first channel cropped image comprising the target object from the first channel image;
generate a second channel cropped image comprising the target object from the second channel image; and
input the first channel cropped image and the second channel cropped image to the focus determination model and output the position of the lens.

18. The electronic device of claim 17, wherein the focus determination model is a model trained to output the position of the lens for focusing on the target object based on PD pixel values and image pixel values included in the first channel cropped image and the second channel cropped image, in response to receiving the first channel cropped image and the second channel cropped image as input.

19. The electronic device of claim 13, wherein the image is an image generated by an image sensor comprising PD pixels having a density less than or equal to a threshold density.

20. The electronic device of claim 13, wherein the image pixel values comprising the information on the image comprise either one or both of a value of image pixels adjacent to PD pixels in the image and a value of all image pixels included in an image sensor.
